(19) United States
(12) Patent Application Publication
(10) Pub. No.: US 2005/0212281 A1
(43) Pub. Date: Sep. 29, 2005

(54) Hydrogen fueling trailer

(76) Inventors: Gerald E. Gore, Kutztown, PA (US); Francine J. Gore, Kutztown, PA (US)

Correspondence Address: EZRA SUTTON, P.A.;PLAZA 9 BUILDING, SUITE 201, 900 ROUTE 9 NORTH, WOODBRIDGE, NJ, 07095, US

(21) Appl. No.: 10/811,251

(22) Filed: Mar. 26, 2004

(51) Int. Cl. B60J 1/00

(52) U.S. Cl. 280/837; 280/423.1

(57) ABSTRACT

A combined system for hauling a cargo tanker of other trailer, including a single tractor having one engine for moving itself and for pulling a single trailer, the single tractor and the single trailer having mounted thereon; a tank of liquid hydrogen; a fuel cell for providing electricity to the engine; a means for mounting the tank of liquid hydrogen on the trailer unit; and the fuel cell and the tank of liquid hydrogen each being responsive to the operation of the engine and a fifth (5^{th}) wheel mounted and attached to the trailer unit.

### FIELD OF THE INVENTION

This invention relates generally to fueling and refueling of hydrogen powered tractors.

### BACKGROUND OF THE INVENTION

It is known in the art that hydrogen is a fuel. Hydrogen can be combusted to produce mechanical energy, and it can be blended to be a combined fuel. Hydrogen bums cleanly with little or not pollutants. Hydrogen is also a fuel stock for fuel cells and in that utilization there is no combustion and the energy derived is electrical and thermal in nature.

Hydrogen is known in the art also as a process gas. It is in this application that it produced and utilized throughout the world. Because of its energy density, it is easy to transport by pipeline, more easily than natural gas. Hydrogen is also transported by a tractor and trailer to a commercial or industrial site. The commercial or industrial concern draws the hydrogen from the trailer to utilize the hydrogen gas in processes within the business. Once the hydrogen has been consumed at the site, an additional load of hydrogen is requested and delivered to the site to be used on site.

Hydrogen is often transported by rail or by tractor that is fueled by hydrocarbon fuels such as diesel or gasoline pulling a long trailer of hydrogen-filled tubes or a tank of hydrogen. The prior art has not recognized that a single tractor trailer unit can be provided with all of the equipment and accessories for running a fuel cell and fueling that unit by hydrogen. The prior art typically brings a hydrocarbon fueled tractor pulling or transporting a trailer with hydrogen tanks and manifold system or assemblies to the industrial or commercial site. The hydrogen trailer is unhooked from the tractor. The tractor or cab unit then returns to the terminal. The trailer loaded with hydrogen tanks then remains at the site until the hydrogen is completely consumed on site. At this time, the cab goes to the yard hooks up a trailer of hydrogen in a tank or tube form to be brought to the site. At the site, the trailer with the full tanks is unhooked and dropped off at the site and the trailer with the empty tanks is hooked to the cab and returned to the hydrogen production facility or tank yard. There the tanks are refilled with hydrogen and await the needs of the next customer.

The fueling of the tractor to haul the trailer is as simple as pulling into the truck fleet yard and filling the tractors fuel tanks with diesel or pulling into a gas service station and filling the tanks with diesel and paying for the fuel with a credit card or cash. The same is not true for the tractor that uses hydrogen as a fuel. This is a focus of the present invention.

It is of the primary object of this present invention to provide a combined tractor trailer unit which utilizes a single tractor that is electrically powered by a fuel cell or cells and a single trailer to provide the hydrogen fuel to be consumed by the tractor to allow the combined tractor trailer unit to pull an additional trailer that is a cargo or freight trailer, a tanker trailer or other trailer.

### SUMMARY OF THE DRAWINGS

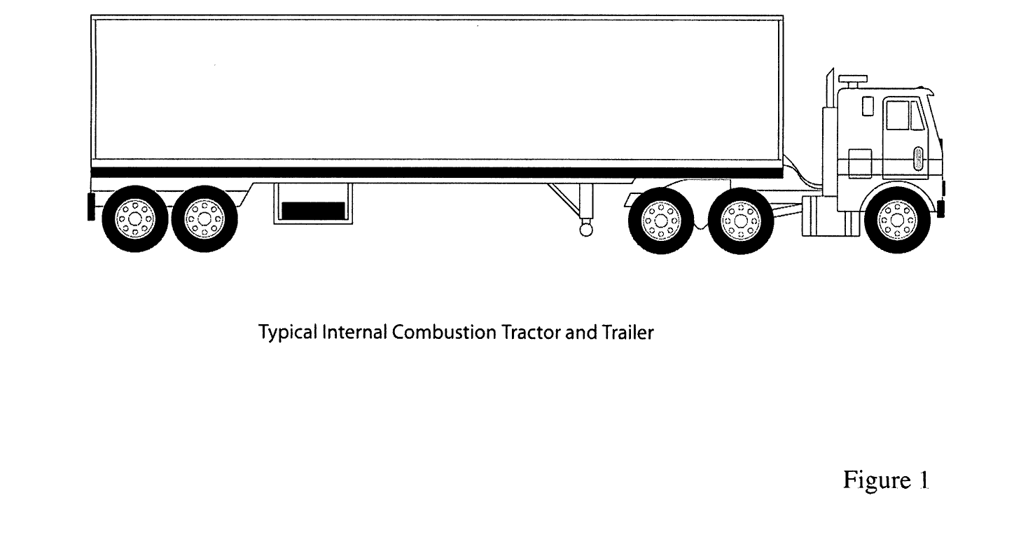

A. FIG. 1 shows a typical diesel internal combustion tractor and trailer.

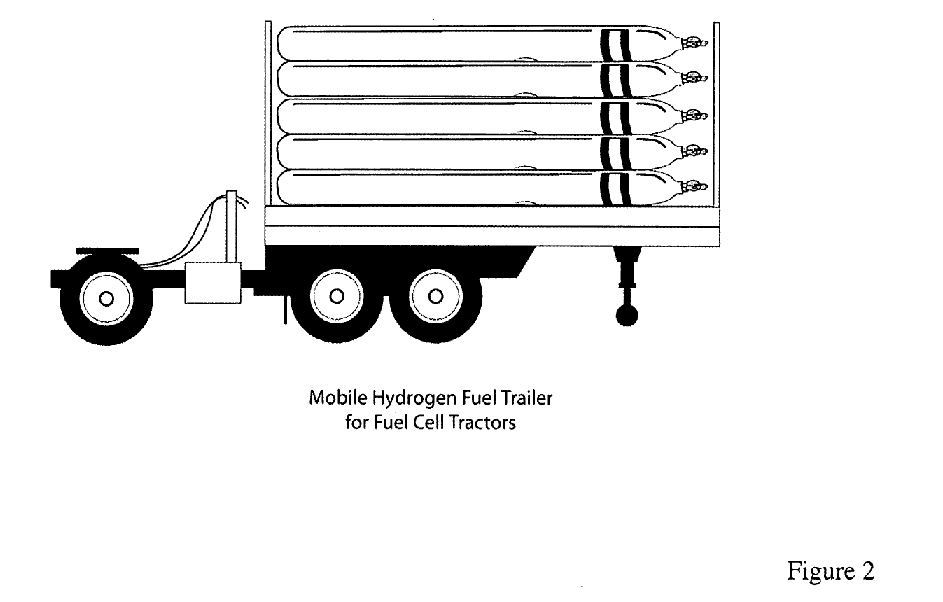

B. FIG. 2 shows an innovative fuel trailer unit or system that is filled with compressed hydrogen tanks. The trailer unit has its own fifth (5^{th}) wheel for attaching a trailer or tanker to be pulled behind the trailer. The fuel cell tractor unit draws hydrogen fuel from this trailer unit. The trailer unit has a front and rear protective panels. The trailer is open or uncovered for illustration purposes.

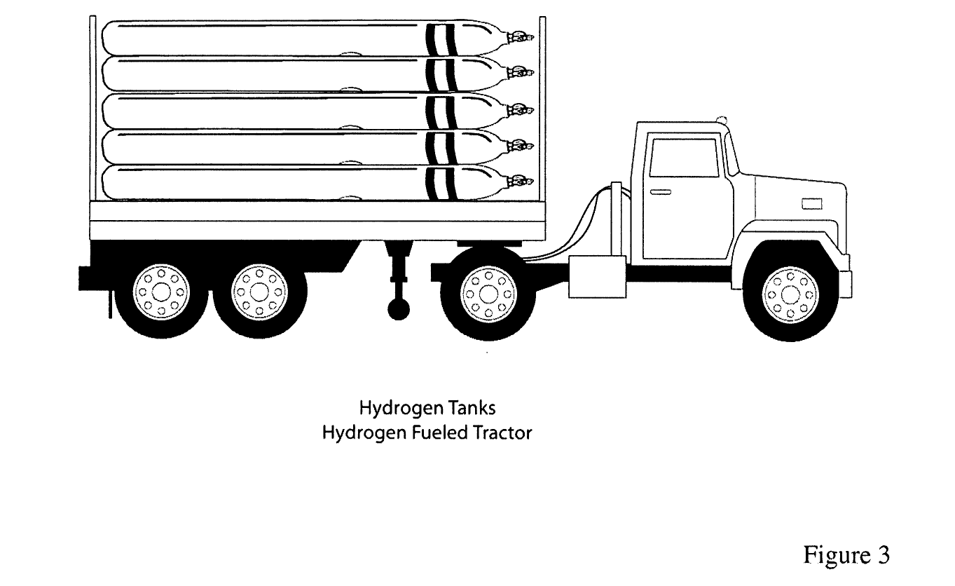

C. FIG. 3 shows a hydrogen fueled internal combustion tractor pulling a trailer loaded with compressed hydrogen tubes.

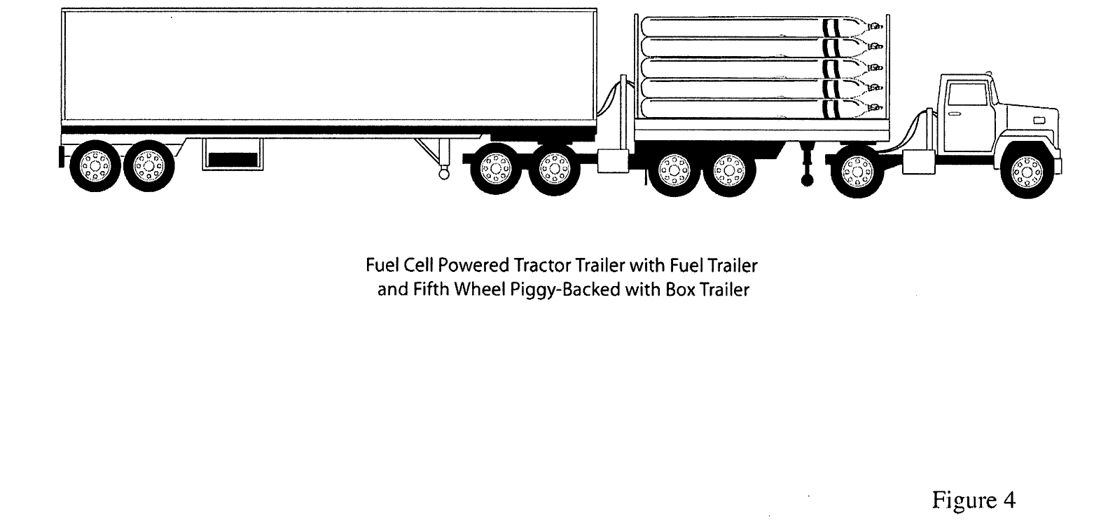

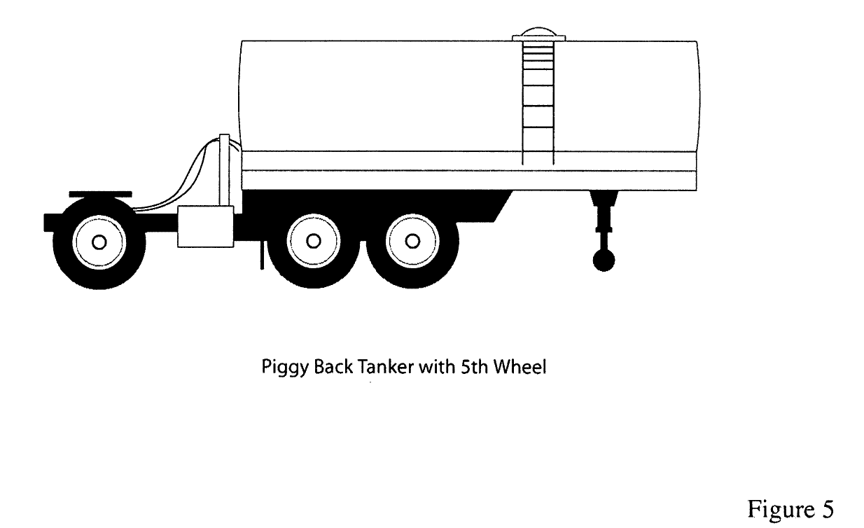

D. FIG. 4 shows a tractor that is motivated by an electric motor or multiple motors that obtains its electricity from a fuel cell that is fueled by hydrogen. The fuel cell tractor of this illustration can be used in accordance with the present invention with the trailer unit of FIG. 5. The figure shows a typical cargo trailer that is attached to the fifth wheel of the trailer unit that is in turn attached to the fifth wheel of a preceding tractor unit.

E. FIG. 5 shows a unique trailer that is a hydrogen tanker that is filled with compress hydrogen and uniquely carries its own wheeled fifth (5^{th}) wheel. The hydrogen from the tanker is not to carry the hydrogen to a industrial or commercial site as a process gas the hydrogen of this tanker is to fuel the tractor or cab that will pull the tanker and a following trailer or tanker attached to the fifth (5^{th}) wheel of the fuel trailer.

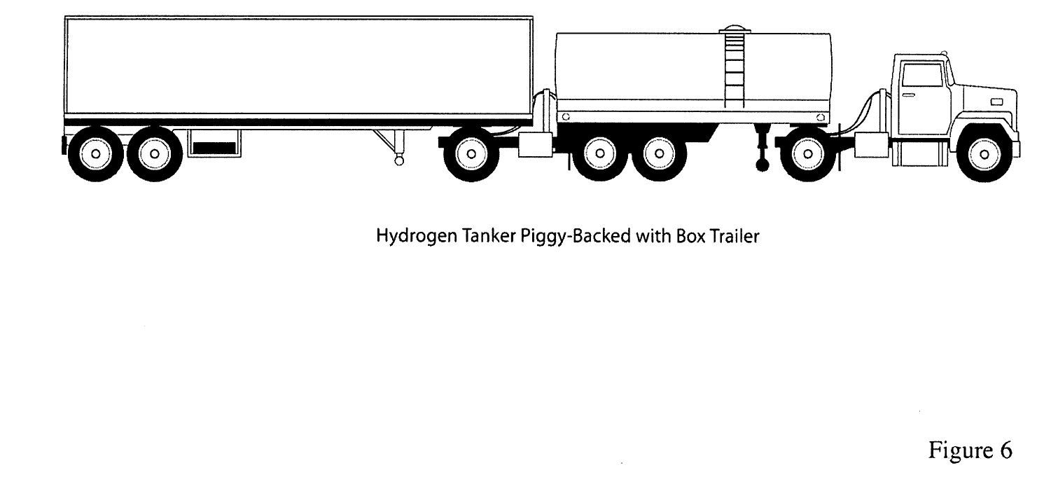

F. FIG. 6 shows the unique fuel cell powered truck and fuel tanker unit or system that in turn is pulling a typical cargo trailer.

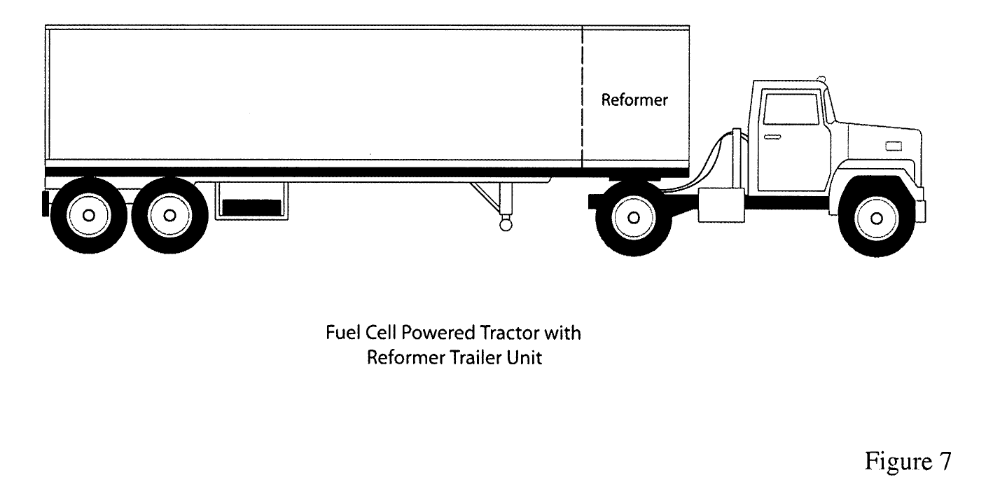

G. FIG. 7 shows the fuel cell tractor unit with on board hydrocarbon fuel and a trailer unit that has the fuel reformer inside the trailer. The reformer system is also available on the tractor unit.

### SUMMARY OF THE INVENTION

A single tractor unit is provided for pulling a trailer fuel unit. The trailer unit is itself not unlike a tractor in that the trailer unit has a fifth (5^{th}) wheel. The tractor unit is electrically powered by a single or multiple electric motors.

The motive power of the tractor unit is derived from electric motors. The tractor unit, in which the tractor itself drives a single or a plurality of electric motors, and the pumps and motors associated with a liquid hydrogen system, which is used for injecting gaseous hydrogen into a fuel cell or other power plant.

In an alternative mode, the liquid hydrogen system is replaced with one or more gaseous hydrogen tanks or tanks that contain hydrogen-holding materials. Alternatively, the gaseous hydrogen source is one or more tanks of compressed hydrogen gas.

### PREFERRED EMBODIMENT OF THE INVENTION

In order that the present invention may be fully practiced, it must be discussed that although not a preferred embodiment of the invention, a number of vehicular power plants and power plant types can utilize the hydrogen. Hydrogen can be combusted in a turbine, an internal combustion engine, including the Wankle or Sterling Engines. Hydrogen can be utilized in a Proton Exchange Membrane Fuel Cell, it can also be blended with other gaseous fuels for vehicular or other applications.

Hydrogen is the preferred fuel for the preferred embodiment of the present invention. The use of fuel cells in vehicles allows them to be electric generators. PowerPark® Technologies allows a vehicle or vehicles to produce energy while the vehicle is at rest with the fuel cell or other power plant operating.

The preferred embodiment and the claims of the present invention incorporate taking electricity from off board of the tractor unit.

A. FIG. 1 shows a typical diesel internal combustion tractor and trailer.

B. FIG. 2 shows an innovative fuel trailer unit or system that is filled with compressed hydrogen tanks. The trailer unit has its own fifth (5^{th}) wheel for attaching a trailer or tanker to be pulled behind the trailer. The fuel cell tractor unit draws hydrogen fuel from this trailer unit. The trailer unit has a front and rear protective panels.

The trailer is open or uncovered for illustration purposes. In practice for cryogenic systems it would be covered and cooled. For low pressure hydrogen the trailer unit is also covered but more for security. The fuel cell tractor unit as an embodiment has hydrogen tubes on the tractor unit behind the cab, and behind the sleeper unit. The tractor unit has the appearance of a double wide sleeper.

C. FIG. 3 shows a hydrogen fueled internal combustion tractor pulling a trailer loaded with compressed hydrogen tubes.

D. FIG. 4 shows a tractor that is motivated by an electric motor or multiple motors that obtains its electricity from a fuel cell that is fueled by hydrogen. The fuel cell tractor of this illustration can be used in accordance with the present invention with the trailer unit of FIG. 5. The figure shows a typical cargo trailer that is attached to the fifth wheel of the trailer unit that is in turn attached to the fifth wheel of a preceding tractor unit.

The tractor unit can also hydrogen tubes on board as noted above in FIG. 2. However, due to the energy density of hydrogen the liquid hydrogen even though more expensive and costly than gaseous hydrogen is the preferred embodiment for the long haul. Due to the weight of the pressurized hydrogen containers and systems, the trailer unit is the preferred embodiment to fuel the tractor unit.

E. FIG. 5 shows a unique trailer that is a hydrogen tanker that is filled with compress hydrogen and uniquely carries its own wheeled fifth (5^{th}) wheel. The hydrogen from the tanker is not to carry the hydrogen to a industrial or commercial site as a process gas the hydrogen of this tanker is to fuel the tractor or cab that will pull the tanker and a following trailer or tanker attached to the fifth (5^{th}) wheel of the fuel trailer.

F. FIG. 6 shows the unique fuel cell powered truck and fuel tanker unit or system that in turn is pulling a typical cargo trailer.

G. FIG. 7 shows the fuel cell tractor unit with on board hydrocarbon fuel and a trailer unit that has the fuel reformer inside the trailer. The reformer system is also available on the tractor unit.

### SIGNIFICANCE OF THE INVENTION

This is a significant invention. The significance of this invention involves providing and teaching the processes, methods, and apparatus to enhance and improve hydrogen powered vehicles and provides methods and apparatus to expedite the introduction of commercial fuel cell vehicles in commercial applications. This invention also teaches method and apparatus to provide for the fueling and refueling of fuel cell vehicles especially trucks.

This invention does not only apply to trucks and this patent and in its claims truck is extended to other vehicles as well and trailer unit is extended and claimed herein to extend to other embodiments as well and will make them more workable and more commercially viable systems including the following:

A. This invention brings a tractor unit and trailer unit as a mobile generator.

B. Cryogenic hydrogen is a costly commodity but this invention utilizes on board or off board hydrogen in a trailer unit for locomotion of a tractor unit and also utilizes the hydrogen to produce electricity without pollutants. The electricity can be utilized for on board or off board load applications.

C. Cryogenic hydrogen systems are costly to operate and do not have high operating efficiencies but due to their energy density this invention uses the vehicles energy systems to produce electricity to help power the cryogenic hydrogen system and reduce cost and increase efficiency of this system. The trailer unit of this invention is the perfect asset to carry the fuel to fuel the tractor unit.

D. This invention is uniquely is able to move to locations or systems to provide electricity or consume hydrogen as needed. In addition to carrying vitally needed cargo.

E. This invention uses tractor and trailer units also as mobile power plants to consume and utilize hydrogen. These vehicles have on board storage systems and can there store hydrogen on board while they are consuming hydrogen. Since this invention utilizes hydrogen stored under pressure, this invention can uniquely utilize its mobile assets to uniquely dispense hydrogen gas also.

This invention will uniquely allow trucks to be on the highway that are fuel cell vehicles fueled by hydrogen. As of this writing, there are no hydrogen filling stations on the highway, none under construction. The present invention innovatively and uniquely provides viable methods and apparatus to put these vehicles on the road now. The embodiments of the trailer unit are at the truck terminal or truck stops. “To fill them Up” they just drop empty trailer units at the terminal or stop and pick up a full trailer unit.

This invention is vital and significant. This invention is also significant in the reduction of pollutants and our dependence on foreign oil.

1. A combined system for hauling a cargo, tanker of other trailer, comprising: a single tractor having an one engine for moving itself and for pulling a single trailer, said single tractor and said single trailer having together mounted thereon: a tank of liquid hydrogen; a fuel cell for providing electricity to said engine; a means for mounting said tank of liquid hydrogen to said trailer unit; and said fuel cell and said tank of liquid hydrogen each being responsive to the operation of said engine and a fifth (5^{th}) wheel mounted and attached to said trailer unit.

2. The system according to claim 1, including in addition thereto, a trailer of cargo or a tanker trailer is attached to the fifth (5^{th}) wheel of said trailer unit.

3. The system according to claim 1, wherein the fuel cell is a Proton Exchange Membrane Fuel Cell.

4. The system according to claim 1, including in addition thereto, said engine of said tractor is an electric motor.

5. The system according to claim 1, including in addition thereto, a hydraulic pump driven by said engine of said tractor for manipulating the output of said tank of liquid hydrogen.

6. The system according to claim 1, including the addition thereto multiple electric motors to drive the tractor tailor unit to pull said trailer or tanker.

7. The system according to claim 1, wherein the hydrogen fuel and said fuel cell are attached on board said trailer unit.

8. The system according to claim 1, wherein the hydrogen fuel is in a gaseous form.

9. The system according to claim 1, including the means for taking electric power off said tractor trailer unit to power a load in said trailer or tanker.

10. The system according to claim 1, including the means for taking electric power off said tractor trailer unit to power a load off board of said tractor trailer unit.

11. A combined system for hauling a cargo, tanker or other trailer, comprising: a single tractor having an engine for moving itself and for pulling a single trailer said single tractor and said single trailer having together mounted each thereon: fifth (5^{th}) wheels, one mounted and attached to said tractor and one mounted and attached to the end of said trailer unit.

12. The system according to claim 11, including the addition thereto the engine is a hydrogen combustion engine, such as but not limited to a Wankel engine.

13. The system according to claim 11, including the addition thereto the trailer unit contains means of storing hydrogen to fuel said engine.

14. The system according to claim 11, including the addition of a hydrogen fuel cell to the tractor to produce electricity to drive the engine.

15. The system according to claim 13, including the addition thereto the means to transport said hydrogen to said tractor fuel cell.

16. The system according to claim 11, including the addition of a hydrogen fuel cell to the trailer containing the hydrogen fuel.

17. The system according to claim 16, including the means of connecting the fuel cell to the hydrogen fuel tanks.

18. The system according to claim 13, including structural barrier affixed to the front and rear of said trailer unit with the hydrogen tanks between these structural barriers.

19. The system according to claim 11, including the addition of structural barrier affixed to the front and rear of said trailer unit with the means to affix a hydrogen tank between these structural barriers.

20. The system according to claim 11, including the addition of a means affix the hydrogen tubes to said trailer unit.

21. The system according to claim 11, including the addition of means to transport the compressed hydrogen of said fuel trailer to the hydrogen fuel cell located on said tractor of said engine motor to drive the tractor trailer unit to pull said trailer or tanker.

22. The system according to claim 11, including in addition thereto, a trailer of cargo or a tanker trailer is attached to the fifth (5^{th}) wheel of said trailer unit.

23. The system according to claim 11, wherein the fuel cell is a Proton Exchange Membrane Fuel Cell.

24. The system according to claim 11, including in addition thereto, said engine of said tractor is an electric motor.

25. The system according to claim 11, including in addition thereto, a hydraulic pump driven by said engine of said tractor for manipulating the output of said tank of liquid hydrogen.

26. The system according to claim 11, including the addition thereto multiple electric motors to drive the tractor trailer unit to pull said trailer or tanker.

27. The system according to claim 11, wherein the hydrogen fuel and said fuel cell are attached on board said trailer unit.

28. The system according to claim 11, wherein the hydrogen fuel is in a gaseous form.

29. The system according to claim 1, including in addition thereto, a hydrogen storage system that is cryogenic to produce gaseous hydrogen.

30. The system according to claim 1, including the addition thereto, a hydrogen system that is solid-in-metal hydrides.

31. The system according to claim 1, including the in addition thereto, a hydrocarbon reformer to produce hydrogen.

32. The system according to claim 26, including the addition thereto, tanks of hydrocarbon fuel and means to transfer the hydrocarbon fuel to said reformer.

33. The system according to claim 11, including in addition thereto, a hydrogen storage system that is cryogenic to produce gaseous hydrogen.

34. The system according to claim 11, including the addition thereto, a hydrogen system that is solid-in-metal hydrides.

35. The system according to claim 11, including the in addition thereto, a hydrocarbon reformer to produce hydrogen.

36. The system according to claim 30, including the addition thereto, tanks of hydrocarbon fuel and means to transfer the hydrocarbon fuel to said reformer.

37. The system according to claim 11, including the means for taking electric power off said tractor trailer unit to power a load in said trailer or tanker.

38. The system according to claim 11, including the means for taking electric power off said tractor trailer unit to power a load off board of said tractor trailer unit.

39. A combined system for providing fuel to a single tractor comprising: a single trailer and a fifth (5^{th}) wheel unit with at least two wheels and a fuel supply and a means of attaching said fuel supply to said trailer and a means of providing said fuel to said single tractor.

40. The system according to claim 34, including the addition thereto, a single tractor with a limited supply of on board fuel to power the tractor until said tractor is attached to said trailer to obtain a larger supply of fuel.

41. The system according to claim 34, including the addition thereto, a single tractor with a limited supply of on board batteries to produce electricity to power the tractor until said tractor is attached to said trailer to obtain a supply of fuel.

42. The system according to claim 34, including the addition thereto, a single tractor that is a fuel cell and electric motor or motors combination tractor.

43. The system according to claim 34, including the addition thereto, a single tractor that is a hybrid electric fuel cell tractor system, comprising: a single tractor having an engine for moving itself and for pulling a single trailer said engine is an electric motor or motors said single tractor and said single trailer having together mounted each thereon:
